(19) United States
(12) Patent Application Publication
(10) Pub. No.: US 2007/0062555 A1
(43) Pub. Date: Mar. 22, 2007

(54) Ultrasonic cleaning system and method

(75) Inventors: Sean Chang, Taoyuan Hsien (TW); Chao-Sen Chang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC., Taoyuan Hsien (TW)

(21) Appl. No.: 11/356,018

(22) Filed: Feb. 17, 2006

(30) Foreign Application Priority Data
Sep. 22, 2005 (TW) 094132768

(51) Int. Cl. B08B 3/12

(52) U.S. Cl. 134/1; 134/184

(57) ABSTRACT

An ultrasonic cleaning system includes an ultrasonic cleaner and a bubble generator. The bubble generator generates a micro-emulsified liquid containing a plurality of micro-to-nano-sized bubbles. The ultrasonic cleaner communicates with the bubble generator such that the micro-emulsified liquid is able to be outputted into the ultrasonic cleaner for performing an ultrasonic oscillation cleaning procedure.

### CROSS REFERENCE TO RELATED APPLICATIONS

This Non-provisional application claims priority under U.S.C. § 119(a) on Patent Application No(s). 094132768, filed in Taiwan, Republic of China on Sep. 22, 2005, the entire contents of which are hereby incorporated by reference.

### BACKGROUND OF THE INVENTION

1. Field of Invention

The invention relates to a cleaning system and method and in particular to a cleaning system and method using ultrasound and micro-to-nano-sized bubbles.

2. Related Art

Since the ultrasonic cleaning procedure is easily operated and has a good clean effect, it is widely used in industries and daily lives.

As shown in FIG. 1, a conventional ultrasonic cleaner 11 includes an oscillator 111, a cleaning tank 112 and a fixing carrier 113. The uncleaned object 12 is placed in the fixing carrier 113, and the fixing carrier 113 is disposed within the cleaning tank 112. The oscillator 111 oscillates the liquid 114 in the cleaning tank 112 in a high speed to generate a pressure change between molecules of the liquid 114. This phenomenon, which generates some small vacuum spaces, is called cavitation. At this moment, the air dissolved in the water enters the vacuum spaces to form small bubbles 115. When the bubbles are pressured by the oscillation and then crack, the obvious pressure differential between the bubbles and the environment can strip the suspensions from the uncleaned object 12.

However, although the ultrasonic cleaning procedure is easily operated and has a good clean effect, the flow field of the ultrasound in the cleaning tank 112 is non-uniform due to the relative locations of the oscillator 111, the cleaning tank 112, the fixing carrier 113 and the uncleaned object 12. This will cause the cleaning dead space, resulting in the imperfect clean effect.

It is therefore an important subject of the invention to provide an ultrasonic cleaning system and method, which can enhance the clean effect for cleaning parts of the uncleaned object that are difficultly cleaned. Moreover, the production efficient and product yield for the uncleaned object can be increased.

### SUMMARY OF THE INVENTION

In view of the foregoing, the invention is to provide an ultrasonic cleaning system and method that can enhance the clean effect.

To achieve the above, an ultrasonic cleaning system of the invention includes an ultrasonic cleaner, and a bubble generator. In the invention, the bubble generator is able to generate a micro-emulsified liquid containing a plurality of micro-to-nano-sized bubbles. The bubble generator communicates with the ultrasonic cleaner and outputs the micro-emulsified liquid into the ultrasonic cleaner for performing an ultrasonic oscillation cleaning procedure.

To achieve the above, an ultrasonic cleaning method of the invention includes the following steps of: providing an ultrasonic cleaner, generating a micro-emulsified liquid containing a plurality of micro-to-nano-sized bubbles, outputting the micro-emulsified liquid to the ultrasonic cleaner, and performing an ultrasonic cleaning procedure.

In the present invention, the sizes of the above-mentioned micro-to-nano-sized bubbles are ranged from about 1 nanometer to 100 micrometers.

As mentioned above, the ultrasonic cleaning system and method of the invention utilizes the micro-emulsified liquid containing the micro-to-nano-sized bubbles to enhance the clean effect for cleaning parts of the uncleaned object that are difficultly cleaned. Moreover, the production efficient and product yield for the uncleaned object can be increased.

### BRIEF DESCRIPTION OF THE DRAWINGS

The invention will become more fully understood from the detailed description given herein below illustration only, and thus is not limitative of the present invention, and wherein:

FIG. 1 is a schematic view of a conventional ultrasonic cleaner;

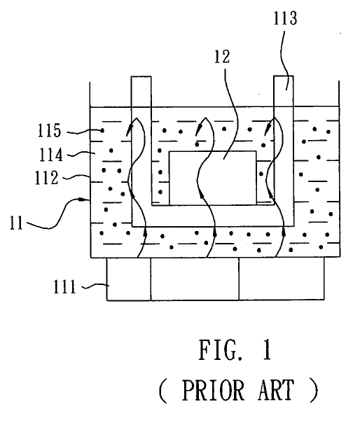

FIG. 2 is a schematic view showing an ultrasonic cleaning system according to a first embodiment of the invention;

FIG. 3 is a schematic view showing an ultrasonic cleaning system according to a second embodiment of the invention; and

FIG. 4 is a flow chart of an ultrasonic cleaning method according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

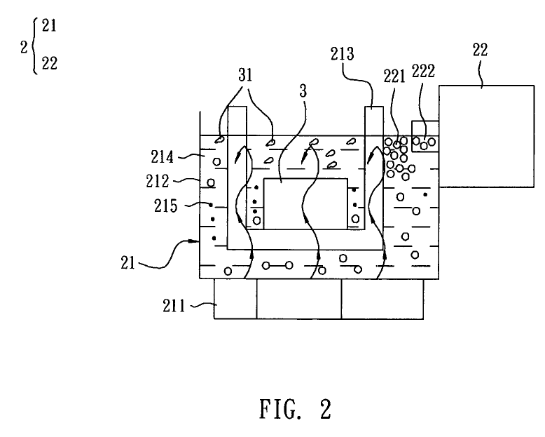

With reference to FIG. 2, an ultrasonic cleaning system 2 according to a preferred embodiment of the invention includes an ultrasonic cleaner 21 and a bubble generator 22. The bubble generator 22 includes an oscillator 211, a cleaning tank 212 located above the oscillator 211, and a fixing carrier 213 disposed within the cleaning tank 212. The bubble generator 22 generates a micro-emulsified liquid 222 containing a plurality of micro-to-nano-sized bubbles 221. Also, the bubble generator 22 communicates with the cleaning tank 212 of the ultrasonic cleaner 21 so that the micro-emulsified liquid 222 can be outputted into the ultrasonic cleaner 21.

When the ultrasonic cleaning procedure is performed, the micro-emulsified liquid 222 is firstly generated by the bubble generator 22 and then outputted into the cleaning tank 212. The micro-emulsified liquid 222 functions as a cleaning liquid 214 solely. Alternatively, the micro-emulsified liquid 222 may be mixed with a cleaning liquid 214 in the cleaning tank 212 in advance. Then, an uncleaned object 3 is placed in the fixing carrier 213. After that, the oscillator 211 oscillates the cleaning liquid 214 in the cleaning tank 212 in a high speed to generate a pressure change between molecules of the cleaning liquid 214 (i.e. the cavitation phenomenon). In other words, some small vacuum spaces are generated. At this moment, the air dissolved in the cleaning liquid 214 enters the vacuum spaces to form small bubbles 215. When the bubbles 215 and the micro-to-nano-sized bubbles 221 of the micro-emulsified liquid 222 are pressured by the oscillation and then crack, the obvious pressure differential between the bubbles and the environment can strip the suspensions 31 from the uncleaned object 3. In the present embodiment, the sizes of the micro-to-nano-sized bubbles 221 are preferably ranged from 1 nanometer to 100 micrometers for obtaining a better clean effect.

Compared with the prior art, the cleaning liquid 214 in the cleaning tank 212 includes the conventional bubbles 215 caused by the ultrasound and is further mixed with the micro-to-nano-sized bubbles 221. Therefore, the suspensions 31 are efficiently stripped from the uncleaned object 3 by the cracked micro-to-nano-sized bubbles 221. Besides, the ultrasound generated by the oscillator 211 can be refracted by the micro-to-nano-sized bubbles 221 and then uniformly distributed in the cleaning liquid 214. In other words, the flow field of the ultrasound in the cleaning tank 212 is uniform. Thus, the cleaning dead spaces caused by the relative locations of the oscillator 211, the cleaning tank 212, the fixing carrier 213 and the uncleaned object 3 may be eliminated. Furthermore, the micro-to-nano-sized bubbles 221 can carry the suspensions 31 to the top surface of the cleaning liquid 214, so that the suspensions 31 would not stay around the uncleaned object 3 in the cleaning liquid 214.

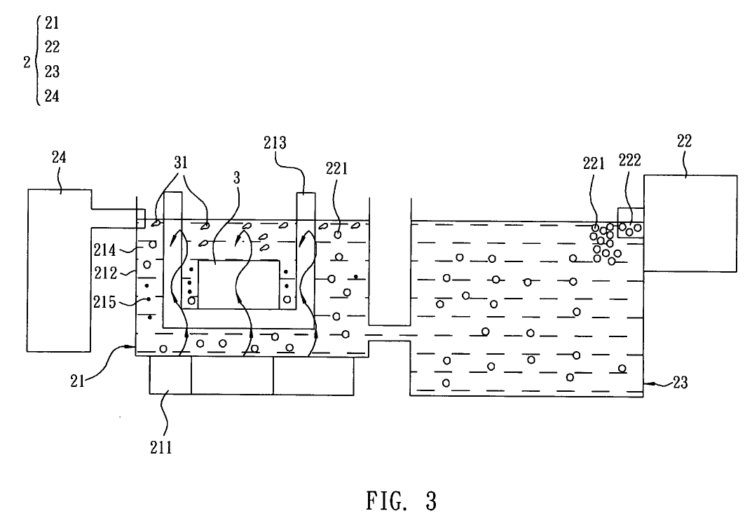

Referring to FIG. 3, an ultrasonic cleaning system 2 according to another embodiment of the invention further includes a liquid tank 23 and an overflow device 24.

The liquid tank 23 is connected to the bubble generator 22 at one side and is communicated to the cleaning tank 212 at another side. In the embodiment, the micro-emulsified liquid 222 containing a plurality of micro-to-nano-sized bubbles 221 is generated by the bubble generator 22 and then outputted into the liquid tank 23. After statically staying in the liquid tank 23 for a period of time, the micro-emulsified liquid 222 is outputted into the cleaning tank 212. The micro-emulsified liquid 222 either functions as a cleaning liquid 214 solely or is mixed with a cleaning liquid 214 in the cleaning tank 212 in advance. The overflow device 24 is communicated to the cleaning tank 212 of the ultrasonic cleaner 21 where is close to the top surface of the cleaning liquid 214 for removing the suspensions 31 generated by the ultrasonic cleaner 21. In more details, the suspensions 31 is carried by the micro-to-nano-sized bubbles 221 to the top surface of the cleaning liquid 214 and then flows into the overflow device 24. As the results, the cleaning liquid 214 can keep clean so as to provide a better cleaning effect.

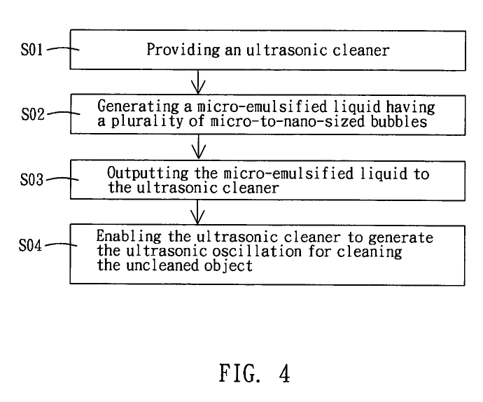

As shown in FIG. 4, an ultrasonic cleaning method according to a preferred embodiment of the invention includes the following steps S01 to S04.

The step S01 is to provide a cleaner having a function of ultrasonic cleaning.

The step S02 is to generate a micro-emulsified liquid containing a plurality of micro-to-nano-sized bubbles. In this embodiment, the micro-emulsified liquid can be generated in cooperation with an additional bubble generator.

The step S03 is to output the micro-emulsified liquid to the ultrasonic cleaner. Alternatively, this step S03 may keep the micro-emulsified liquid in a liquid tank statically for a period of time and then output it to the ultrasonic cleaner.

The step S04 is to enable the ultrasonic cleaner to generate the ultrasonic oscillation for cleaning the uncleaned object. Furthermore, the step S04 may simultaneously utilize an overflow device to remove the suspensions stripped from the uncleaned object out of the ultrasonic cleaner.

The ultrasonic cleaning method of the embodiment can be applied in the ultrasonic cleaning systems as shown in FIG. 2 and FIG. 3. Actually, the steps, effects and theory of the ultrasonic cleaning method of the embodiment are discussed in the previous embodiments, so the detailed descriptions are omitted for concise purpose.

In summary, the ultrasonic cleaning system and method of the invention utilizes the micro-emulsified liquid containing the micro-to-nano-sized bubbles to enhance the clean effect for cleaning parts of the uncleaned object that are difficultly cleaned. Moreover, the production efficient and product yield for the uncleaned object can be increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An ultrasonic cleaning system, comprising:
an ultrasonic cleaner; and
a bubble generator for generating a micro-emulsified liquid containing a plurality of micro-to-nano-sized bubbles, wherein the bubble generator communicates with the ultrasonic cleaner and outputs the micro-emulsified liquid into the ultrasonic cleaner.

2. The ultrasonic cleaning system of claim 1, wherein sizes of the micro-to-nano-sized bubbles are ranged from about 1 nanometer to 100 micrometers.

3. The ultrasonic cleaning system of claim 1, further comprising:
a liquid tank communicated to the ultrasonic cleaner and the bubble generator respectively for allowing the micro-emulsified liquid to statically stay in the liquid tank.

4. The ultrasonic cleaning system of claim 1, further comprising:
an overflow device communicated to the ultrasonic cleaner for removing suspensions generated by the ultrasonic cleaner.

5. The ultrasonic cleaning system of claim 1, wherein the ultrasonic cleaner comprises:
an oscillator;
a cleaning tank located at one side of the oscillator; and
a fixing carrier disposed within the cleaning tank.

6. An ultrasonic cleaning method, comprising steps of:
providing an ultrasonic cleaner;
generating a micro-emulsified liquid containing a plurality of micro-to-nano-sized bubbles;
outputting the micro-emulsified liquid to the ultrasonic cleaner; and
performing an ultrasonic cleaning procedure.

7. The method of claim 6, wherein sizes of the micro-to-nano-sized bubbles are ranged from about 1 nanometer to 100 micrometers.

8. The method of claim 6, wherein the micro-emulsified liquid statically stays for a period of time after being generated and then is outputted into the ultrasonic cleaner.

9. The method claim 8, wherein the micro-emulsified liquid is generated by a bubble generator.

10. The method of claim 9, wherein a liquid tank is disposed between the ultrasonic cleaner and the bubble generator for allowing the micro-emulsified liquid to statically stay in the liquid tank.

11. The method of claim 6, further comprising the step of:
removing suspensions generated by the ultrasonic cleaner.

12. The method of claim 11, wherein the suspensions generated by the ultrasonic cleaner is removed by an overflow device communicated to the ultrasonic cleaner.

13. The method of claim 6, wherein the ultrasonic cleaner comprises:
an oscillator;
a cleaning tank located at one side of the oscillator; and
a fixing carrier disposed within the cleaning tank.
